(19) United States
(12) Patent Application Publication
(10) Pub. No.: US 2015/0160481 A1
(43) Pub. Date: Jun. 11, 2015

(54) OPTICAL DEVICE HAVING MULTIPLE QUANTUM WELL STRUCTURE LATTICE-MATCHED TO GAAS SUBSTRATE, AND DEPTH IMAGE ACQUISITION APPARATUS AND 3D IMAGE ACQUISITION APPARATUS INCLUDING THE OPTICAL DEVICE

(71) Applicant: SAMSUNG ELECTRONICS CO., LTD., Suwon-si (KR)

(72) Inventors: Chang-young PARK, Yongin-si (KR); Yong-hwa PARK, Yongin-si (KR); Jang-woo YOU, Yongin-si (KR)

(73) Assignee: SAMSUNG ELECTRONICS CO., LTD., Suwon-si (KR)

(21) Appl. No.: 14/338,430

(22) Filed: Jul. 23, 2014

(30) Foreign Application Priority Data
Dec. 6, 2013 (KR) 10-2013-0151346

(51) Int. Cl. G02F 1/017; H04N 13/02; H04N 13/00; G02F 1/00

(52) U.S. Cl. CPC G02F 1/017; G02F 1/0081; H04N 13/0253; H04N 13/021; H04N 13/0239; H04N 13/0037; G02F 2001/01766; G02F 2001/0157

(57) ABSTRACT

An optical device includes a gallium arsenide (GaAs) substrate, and a multiple quantum well structure formed on the GaAs substrate and having a quantum well layer and a quantum barrier layer. In the optical device, the quantum well layer is formed of a first semiconductor material that has a bandgap energy which is lower than that of the GaAs substrate and receives a compressive strain from the GaAs substrate, and the quantum barrier layer is formed of a second semiconductor material that has a bandgap energy which is higher than that of the GaAs substrate and receives a tensile strain from the GaAs substrate.

### RELATED APPLICATIONS

This application claims priority from Korean Patent Application No. 10-2013-0151346, filed on Dec. 6, 2013, in the Korean Intellectual Property Office, the disclosure of which is incorporated herein in its entirety by reference.

### BACKGROUND

1. Field

The present disclosure relates to a GaAs-based transmission type optical modulator, a depth image acquisition apparatus, and a three-dimensional (3D) image acquisition apparatus including the optical modulator.

2. Description of the Related Art

Three-dimensional (3D) cameras have a function of measuring a distance from a plurality of points on a surface of an object to the 3D camera in addition to a function of photographing a general image. A variety of algorithms have been suggested to measure a distance between an object and a 3D camera. In this regard, a time-of-flight (TOF) algorithm has been mainly used. According to the TOF algorithm, a time of flight from irradiating illumination light onto an object to receiving the illumination light reflected from the object at a light receiving unit is measured. The TOF of the illumination light may be obtained by measuring a phase delay of the illumination light. A fast optical modulator is used to accurately measure a phase delay.

To acquire a 3D image with precise distance information to an object, an optical modulator exhibiting a superior electro-optical response characteristic has been used. In a related art, a GaAs based semiconductor optical modulator has been mainly used. The GaAs based semiconductor optical modulator has a P-I-N diode structure in which a multiple quantum well (MQW) structure is arranged between a P electrode and an N electrode. According to the P-I-N diode structure, when a reverse bias voltage is applied between the P-N electrodes, the MQW structure forms excitons in a particular wavelength band to absorb light. An absorption spectrum characteristic of the MQW structure moves toward a long wavelength as a reverse bias voltage increases. Accordingly, an absorbance at a particular wavelength may vary with a change in the reverse bias voltage.

A GaAs substrate is used to manufacture a GaAs based optical modulator. The GaAs substrate is opaque and is removed from the optical modulator to form a transmission type optical modulator. After the GaAs substrate is removed, the remaining structure may be transferred onto a SiO₂ substrate that is transparent. However, in a wafer level manufacturing process, a series of manufacturing processes to remove a substrate from an epitaxial structure where electrodes are formed and to transfer the remaining structure onto another SiO₂ substrate is complicated, such that the stability of the wafer level manufacturing process may be low. Recently, a transmission type optical modulator has been developed, in which a portion of the opaque substrate through which light passes is removed and an InGaP layer that is transparent to a light of a wavelength of about 850 nm is added to an epitaxial layer so as to be used as a support for the epitaxial structure. However, an epitaxial thin film may be vulnerable to external shocks or mechanical deformation.

### SUMMARY

Exemplary embodiments may provide a transmission type optical modulator that modulates transmittance of a light in a wavelength band that is transparent to a GaAs substrate, a depth image acquisition apparatus, and a three-dimensional (3D) image acquisition apparatus including the optical modulator.

Additional aspects will be set forth in part in the description which follows and, in part, will be apparent from the description, or may be learned by practice of the presented embodiments.

According to an aspect of the exemplary embodiments, an optical device includes a gallium arsenide (GaAs) substrate, and a multiple quantum well structure formed on the GaAs substrate and having a quantum well layer and a quantum barrier layer. In the optical device, the quantum well layer is formed of a first semiconductor material that has a bandgap energy which is lower than that of the GaAs substrate and receives a compressive strain from the GaAs substrate, and the quantum barrier layer is formed of a second semiconductor material that has a bandgap energy which is higher than that of the GaAs substrate and receives a tensile strain from the GaAs substrate.

The bandgap energy of the quantum well layer may be lower than about 1.43 eV, and a lattice constant of the quantum well layer may be higher than that of the GaAs substrate.

The quantum well layer may include Inx1Ga1-x1As, wherein 0<x1≦0.35 or In1-x1-y1Alx1Gay1As, wherein 0<x1≦0.44 and 0≦y1≦0.98.

The bandgap energy of the quantum barrier layer may be higher than about 1.43 eV, and a lattice constant of the quantum barrier layer may be lower than that of the GaAs substrate.

The quantum barrier layer may include GaAsx2P1-x2, wherein 0.28≦x2≦1), Inx2Ga1-x2P, wherein 0≦x2≦0.34, or Gax2In1-x2Asy2P1-y2, wherein 0.5≦x2≦0.8, 0.4≦y2≦0.77.

The multiple quantum well structure may have a lattice match to the GaAs substrate.

An upper reflective layer and a lower reflective layer may be respectively disposed on an upper portion and a lower portion of the multiple quantum well structure.

The multiple quantum well structure may be configured such that a position of a peak of an absorption spectrum varies based on an applied voltage within a wavelength band that is transparent with respect to the GaAs substrate.

In response to a resonance wavelength of the optical device being λ, the multiple quantum well structure may have an optical thickness of 0.5 nλ, where n is a natural number.

The multiple quantum well structure may include at least ten pairs of the quantum well layer and the quantum barrier well.

The quantum well layer may include Inx1Ga1-x1As, wherein 0<x1≦0.35 or In1-x1-y1Alx1Gay1As, wherein 0<x1≦0.44 and 0≦y1≦0.98.

The quantum barrier well may include GaAsx2P1-x2, wherein 0.28≦x2≦1, Inx2Ga1-x2P, wherein 0≦x2≦0.34, or Gax2In1-x2Asy2P1-y2, wherein 0.5≦x2≦0.8 and 0.4≦y2≦0.77.

At least one microcavity layer may be disposed in at least one of the upper reflective layer and the lower reflective layer, and in response to a resonance wavelength of the optical device being λ, the at least one microcavity layer may have an optical thickness that is an integer multiple of λ/2.

Each of the upper reflective layer and the lower reflective layer may have an optical thickness of λ/4 and is a distributed Bragg reflector (DBR) layer in which a first refractive index layer and a second refractive index layer having different refractive indexes are alternately stacked.

The microcavity layer may be formed of a same material as one of the first refractive index layer and the second refractive index layer.

According to another aspect of the exemplary embodiments, a depth image acquisition apparatus includes a light source configured to irradiate an infrared light to an object, the infrared light being in a wavelength band between about 880 nm to about 1600 nm, a transmission type optical modulator configured to modulate the infrared light reflected from the object, the transmission type optical modulator includes the optical device, wherein an upper reflective layer and a lower reflective layer are respectively disposed on an upper portion and a lower portion of the multiple quantum well structure, a first image sensor configured to sense a light modulated by the transmission type optical modulator and convert a sensed light into an electric signal, and a signal processing device configured to generate depth information from an output of the first image sensor.

The depth image acquisition apparatus may further include a lens device configured to focus the infrared light on the transmission type optical modulator.

The depth image acquisition apparatus may further include a bandpass filter configured to transmit only a light in the wavelength band that is irradiated by the light source, the bandpass filter being disposed between the lens device and the multiple quantum well structure.

According to another aspect of the exemplary embodiments, a three-dimensional (3D) image acquisition apparatus includes a light source configured to irradiate an infrared light to an object, the infrared light being in a wavelength band between about 880 nm to about 1600 nm, a transmission type optical modulator configured to modulate the infrared light reflected from the object, the transmission type optical modulator includes the optical device, wherein an upper reflective layer and a lower reflective layer are respectively disposed on an upper portion and a lower portion of the multiple quantum well structure, a first image sensor configured to sense a light modulated by the transmission type optical modulator and convert a sensed light into an electric signal, a photographing lens configured to focus a visible light reflected from the object and form an optical image, a second image sensor configured to convert the optical image formed by the photographing lens into an electric signal, and a 3D image signal processing device configured to generate depth information and color information from electric signals output from the first image sensor and the second image sensor, and generate a 3D image of the object.

The 3D image acquisition apparatus may further include a beam splitter configured to split the light reflected from the object such that the infrared light travels toward the first image sensor and a visible light travels toward the second image sensor.

### BRIEF DESCRIPTION OF THE DRAWINGS

These and/or other aspects will become apparent and more readily appreciated from the following description of the embodiments, taken in conjunction with the accompanying drawings in which:

FIGS. 1A and 1B are sectional views schematically illustrating a structure of an optical device according to an embodiment and conceptual views for explaining a principle of selecting a material for a multiple quantum well (MQW) structure layer that is lattice-matched to a GaAs substrate;

FIG. 2 is a graph showing a relationship between a lattice constant and bandgap energy of III-V compound semiconductors;

FIGS. 3A and 3B are computer simulation graphs showing the implementation of an optical shutter function by an InGaAs/GaAsP MQW structure layer, each graph showing an absorption spectrum and transmittance according to an applied voltage;

FIG. 4 is a cross sectional view schematically illustrating a structure of an optical device according to an embodiment;

FIG. 5 is a cross sectional view schematically illustrating a structure of an optical device according to a comparative example;

FIG. 6 is a cross sectional view schematically illustrating a structure of an optical device according to another embodiment;

FIG. 7A is a transmission electron microscopy (TEM) image of a MQW structure layer of the optical device of FIG. 6;

FIG. 7B is an enlarged view of an inverse fast Fourier transform (IFFT) pattern of a partial area of FIG. 7A;

FIG. 8 is a graph showing a result of measurement of a photoluminescence (PL) characteristic of the optical device of FIG. 6;

FIG. 9 is a graph showing transmittances when the optical device 200 of FIG. 6 is turned on and off and a difference in the transmittance between the case when the optical device 200 of FIG. 6 is turned on and the case when the optical device 200 of FIG. 6 is turned off;

FIG. 10 is a graph showing a solar light spectrum;

FIG. 11 schematically illustrates a structure of a depth image acquisition apparatus according to an embodiment; and

FIG. 12 schematically illustrates a structure of a three-dimensional (3D) image acquisition apparatus according to an embodiment.

### DETAILED DESCRIPTION OF THE EXEMPLARY EMBODIMENTS

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

The terms such as “first” and “second” are used herein merely to describe a variety of constituent elements, but the constituent elements are not limited by the terms. The terms are used only for the purpose of distinguishing one constituent element from another constituent element. In the following embodiments, the expression of singularity includes the expression of plurality unless clearly specified otherwise in context. When a part may “include” a certain constituent element, unless specified otherwise, it may not be construed to exclude another constituent element but may be construed to further include other constituent elements.

It will be understood that when an element, such as a layer, a region, or a substrate, is referred to as being “on,” “connected to” or “coupled to” another element, it may be directly on, connected or coupled to the other element or intervening elements may be present. In the drawings, the thicknesses of layers and regions are exaggerated for clarity. Also, the thickness or size of each layer illustrated in the drawings may be exaggerated for convenience of explanation and clarity.

When an embodiment may be realized in a different way, a particular process may be performed in order different from the described order. For example, two consecutively described processes may be simultaneously performed or may be performed in order opposite to the described order.

As used herein, the term “and/or” includes any and all combinations of one or more of the associated listed items. Expressions such as “at least one of,” when preceding a list of elements, modify the entire list of elements and do not modify the individual elements of the list.

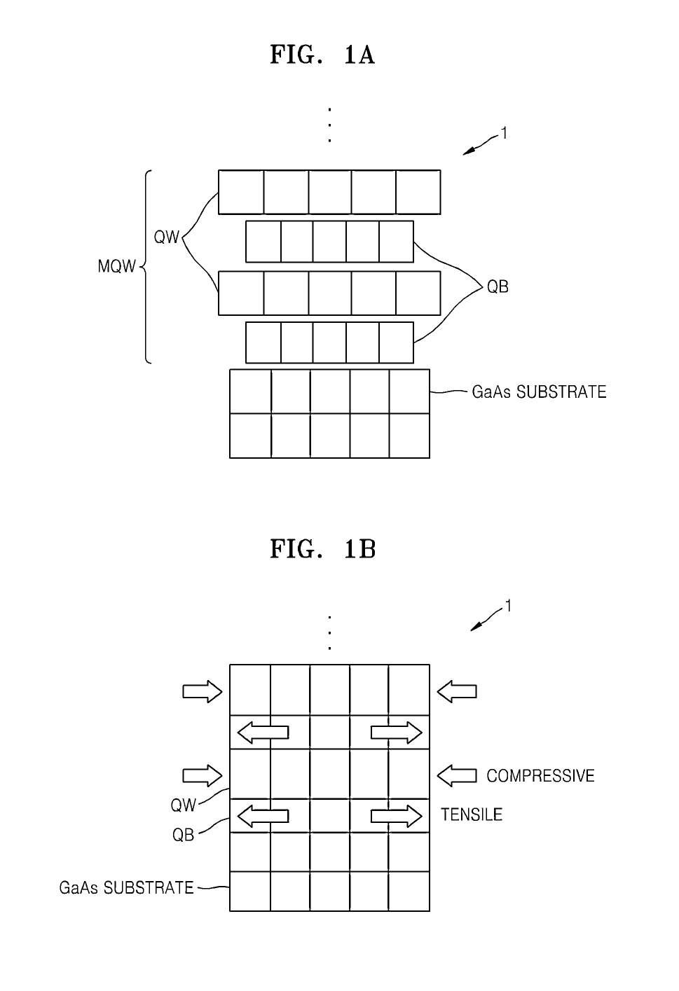

FIGS. 1A and 1B are sectional views schematically illustrating a structure of an optical device 1 according to an embodiment and conceptual views for explaining a principle of selecting a material for a multiple quantum well (MQW) structure layer that is lattice-matched to a Gallium Arsenide (GaAs) substrate.

The optical device 1 includes a GaAs substrate and a multiple quantum well (MQW) structure that includes a quantum well (QW) layer and a quantum barrier (QB) layer.

Materials for the QW layer and the QB layer of the MQW structure are selected such that the MQW structure can modulate transmission of a light of a wavelength band that is transparent with respect to a GaAs substrate and can be lattice-matched to the GaAs substrate. Therefore, the QB layer may be formed of a semiconductor material that has a bandgap energy higher than that of the GaAs substrate and receives a tensile strain from the GaAs substrate. The QW layer may be formed of a semiconductor material that has a bandgap energy lower than that of the GaAs substrate and receives a compressive strain from the GaAs substrate.

When a lattice constant of the QB layer that is formed on the GaAs substrate is smaller than that of the GaAs substrate, the QB layer receives a tensile strain from the GaAs substrate. In other words, as illustrated in FIG. 1A, the QB layer may be formed of a semiconductor material having a lattice constant that is smaller than that of the GaAs substrate. When the lattice constant of the QW layer formed on the GaAs substrate is greater than that of the GaAs substrate, the QW layer receives a tensile strain from the GaAs substrate. In other words, the QW layer may be formed of a semiconductor material having a lattice constant that is smaller than that of the GaAs substrate.

The QB layer and the QW layer having the above lattice constant relationship may have a lattice match to the GaAs substrate as a tensile strain and compressive strain thereof come to strain relaxation as illustrated in FIG. 1B. To this end, a composition ratio of semiconductor materials forming the QB layer and the QW layer is appropriately set.

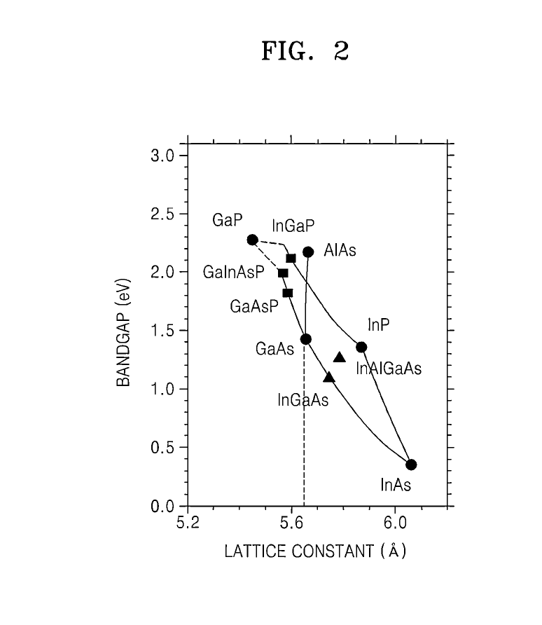

FIG. 2 is a graph showing a relationship between a lattice constant and bandgap energy of III-V compound semiconductors. Referring to the graph of FIG. 2, the QB layer may be formed of a material, for example, GaAsP, GaInAsP, or InGaP, having a bandgap energy higher than about 1.43 eV and a lattice constant lower than that of GaAs. The QW layer may be formed of a material, for example, InGaAs or InAlGaA, having a bandgap energy lower than about 1.43 eV and a lattice constant higher than that of GaAs.

The QW layer may be formed of Inₓ₁Ga₁₋ₓ₁As (0<x1≦0.35) or In_{1-x1-y1}Alₓ₁Ga_{y1}As (0<x1≦0.44 and 0≦y1≦0.98). When the QW layer is formed of Inₓ₁Ga₁₋ₓ₁As, a bandgap energy Egₓ₁ according to a change in x1 is according to the following equation.

Egₓ₁=1.424−1.616(x1)+0.54(x1)²

The above equation is determined based on the graph of FIG. 2. A range of x1 may be set to be about 0<x1≦0.35 to satisfy Egₓ₁≦1.43.

When the QW layer is formed of In_{1-x1-y1}Alₓ₁Ga_{y1}As, the equation of the bandgap energy Eg according to values x1 and y1 is determined from the graph of FIG. 2. The ranges of values x1 and y1 of In_{1-x1-y1}Alₓ₁Ga_{y1}As may be set to 0<x1≦0.44 and 0≦y1≦0.98 to satisfy Eg_{x1y1}<1.43.

The QB layer may be formed of GaAsₓ₂P₁₋ₓ₂ (0.28≦x2≦1), Inₓ₂Ga₁₋ₓ₂P (0≦x2≦0.34), or Gaₓ₂In₁₋ₓ₂As_{y2}P_{1-y2} (0.5≦x2≦0.8 and 0.4≦y2≦0.77). When the QB layer is formed of GaAsₓ₂P₁₋ₓ₂, the bandgap energy Egₓ₂ according to a change of x2 is expressed by the following equation.

Egₓ₂=2.775−1.459(x2)+0.108(x2)²

The above equation is determined from the graph of FIG. 2. The range of x2 of GaAsₓ₂P₁₋ₓ₂ may be determined to be 0.28≦x2≦1 to satisfy Egₓ₂>1.43.

In the same method, when the QB layer is formed of Inₓ₂Ga₁₋ₓ₂P and Gaₓ₂In₁₋ₓ₂As_{y2}P_{1-y2}, the range of x2 of Inₓ₂Ga_{1-αx2}P may be set to be 0≦x2≦0.34 and the ranges of x2 and y2 of Gaₓ₂In₁₋ₓ₂As_{y2}P_{1-y2} may be set to be 0.5≦x2≦0.8 and 0.4≦y2≦0.77, respectively, so that the bandgap energy is higher than 1.43.

A pair of the QB layer and the QW layer may be adjusted in detail so as to have a lattice match to the GaAs substrate within the above composition range. An exemplary method of forming the QB layer and the QW layer of Inₓ₁Ga₁₋ₓ₁As (0<x1≦0.35) and GaAsₓ₂P₁₋ₓ₂ (0.28≦x2≦1), respectively, is described below.

A lattice constant a1 of Inₓ₁Ga₁₋ₓ₁As according to x1 may be determined from the graph of FIG. 2 as follows.

a1=5.6536+0.4054(x1)²

A lattice constant a2 of GaAsₓ₂P₁₋ₓ₂ according to x2 may be determined from the graph of FIG. 2 as follows.

a2=2.775−1.459(x2)+0.108(x2)²

The QW layer and the QB layer may be set to In_{0.15}Ga_{0.85}As and GaAs_{0.699}P_{0.301}, respectively, from the conditions that a1=a2 and 0<x1≦0.44 and 0.28≦x2≦1. When the QW layer and the QB layer are formed of Inₓ₁Ga₁₋ₓ₁As (0<x1≦0.35) and Inₓ₂Ga₁₋ₓ₂P (0≦x2≦0.34) forming a pair, the QW layer and the QB layer may be set to In_{0.15}Ga_{0.85}As and In_{0.146}Ga_{0.854}P, respectively,

In addition, the pair of the QW layer and the QB layer may be formed in a variety of methods. For example, the QW layer may be formed of In_{0.20}Ga_{0.80}As and the QB layer may be formed of GaAs_{0.599}P_{0.401} or In_{0.194}Ga_{0.806}P. Also, the QW layer may be formed of In_{0.35}Ga_{0.65}As and the QB layer may be formed of GaAs_{0.298}P_{0.702} or In_{0.340}Ga_{0.660}P.

The above detailed numerals are exemplary and the pair of the QW layer and the QB layer may be formed in a variety of forms according to the above-described method.

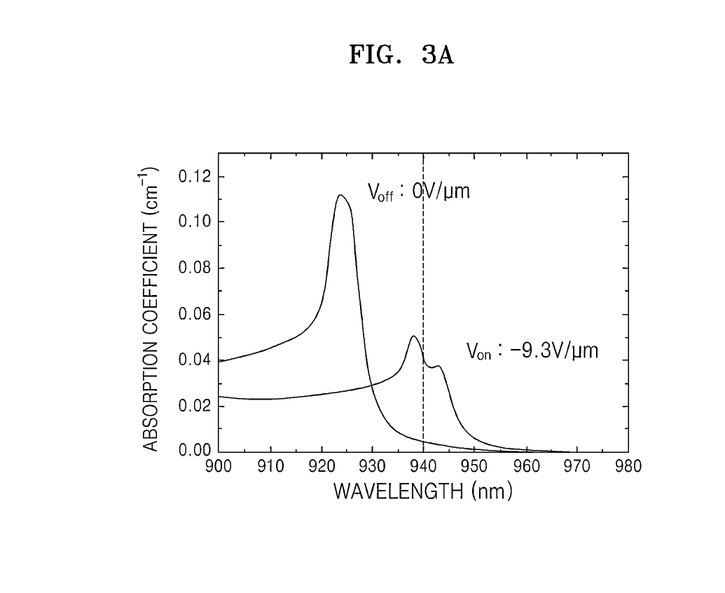

FIGS. 3A and 3B are computer simulation graphs showing the implementation of an optical shutter function by an InGaAs/GaAsP MQW structure layer, each graph showing an absorption spectrum and transmittance according to an applied voltage.

Referring to FIG. 3A, the shape of the absorption spectrum varies according to whether a voltage generating electric field in the MQW structure is applied. In detail, a peak of the absorption spectrum and a wavelength band where a peak value is formed may vary. When no voltage is applied, a peak of absorption spectrum is formed at a wavelength of about 923 nm and an absorption coefficient at a wavelength of about 940 nm is almost 0. When a voltage is applied, a peak of absorption spectrum is formed at a wavelength of about 940 nm. In the structure, since an absorption coefficient with respect to a light of a wavelength of about 940 nm varies greatly according to the application of a voltage, the MQW structure may perform a function of an optical shutter with respect to a light of the above wavelength.

Referring to FIG. 3B, when no voltage is applied, a transmittance of a light of a wavelength of about 940 nm is about 68.4%. When a voltage is applied, a transmittance of a light of a wavelength of about 940 nm is about 22.6%. A difference in the transmittance according to the application of a voltage is about 45.8%.

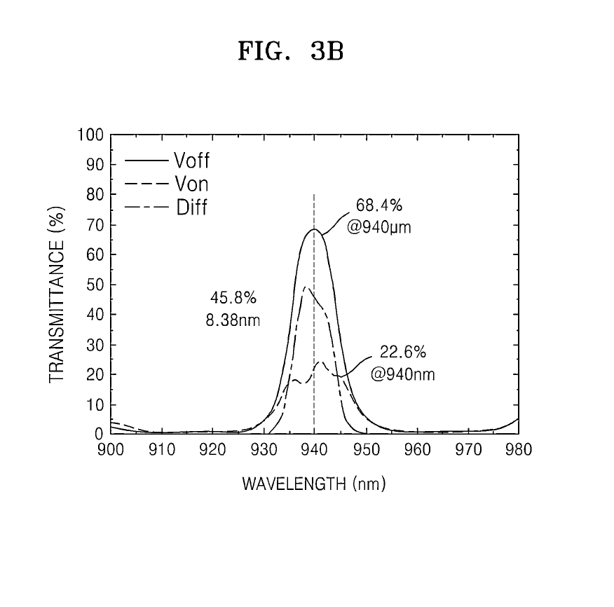

FIG. 4 is a cross sectional view schematically illustrating a structure of an optical device 100 according to an embodiment. Referring to FIG. 4, the optical device 100 includes a GaAs substrate 110, a lower reflective layer 130, an active layer 150 formed of a MQW structure, and an upper reflective layer 170.

The optical device 100 functions as a transmission type optical modulator. That is, the optical device 100 modulates transmission of a light in the wavelength band that is transparent with respect to the GaAs substrate 110, based on an applied voltage. To this end, the MQW structure forming the active layer 150 may be configured such that a position of a peak of an absorption spectrum may vary based on an applied voltage, within the wavelength band that is transparent with respect to the GaAs substrate 110. The wavelength band may be between about 880 nm to about 1600 nm. The optical device 100 according to the present embodiment may be able to on/off modulate a light in the above wavelength band.

The active layer 150 may have a MQW structure including a plurality of pairs of the QB layer and the QW layer. The active layer 150 is an absorption layer where absorption of light to be modulated occurs and may function as a main cavity for Fabry-Perot resonance. To this end, the active layer 150 may have an optical thickness of about 0.5 nλ. The optical thickness is a value obtained by multiplying a physical thickness by a refractive index of a material. Also, “n” is a natural number and “A” is a resonant frequency of the optical device 100, and “λ” may be within the wavelength band that is transparent with respect to the GaAs substrate 110 and may be between about 880 nm and about 1600 nm. The number of pairs of the QW layer and the QB layer may be 10 or more.

The QB layer may be formed of a material that has a bandgap energy higher than that of the GaAs substrate 110 and receives a tensile strain from the GaAs substrate 110. The QB layer may be formed of a material, for example, GaAsP, GaInAsP, or InGaP, which has bandgap energy higher than about 1.43 eV and a lattice constant lower than that of GaAs. The QB layer may be formed of GaAsₓ₂P₁₋ₓ₂ (0.28≦x2≦1), Inₓ₂Ga₁₋ₓ₂P (0≦x2≦0.34), or Gaₓ₂In₁₋ₓ₂As_{y2}P_{1-y2} (0.5≦x2≦0.8 and 0.4≦y2≦0.77).

The QW layer may be formed of a material that has a bandgap energy lower than that of the GaAs substrate 110 and receives a compressive strain from the GaAs substrate 110. The QW layer may be formed of a material, for example, InGaAs or InAlGaAs, which has a bandgap energy lower than about 1.43 eV and a lattice constant higher than that of GaAs. The QW layer may be formed of Inₓ₁Ga₁₋ₓ₁As (0<x1≦0.35) or In_{1-x1-y1}Alₓ₁Ga_{y1}As (0<x1≦0.44 and 0≦y1≦0.98).

A transmission type optical modulator modulates an intensity of a projected light by absorbing part of the incident light in the active layer 150 according to an electric signal when transmitting the incident light. The lower reflective layer 130 and the upper reflective layer 170 transmit part of the incident light and reflect light so that resonance may occur in the active layer 150 that is a main cavity. The reflectance of each of the lower reflective layer 130 and the upper reflective layer 170 may be about 50%.

The lower reflective layer 130 and the upper reflective layer 170 may be doped to simultaneously perform a function of a reflective layer and a function of an electric path. For example, the lower reflective layer 130 may be formed of an n-doped semiconductor material and the upper reflective layer 170 may be formed of a p-doped semiconductor material. Si may be used as an n-type dopant and Mg or Be may be used as a p-type dopant. The active layer 150 is not doped. As such, the optical device 100 may have a P-I-N diode structure.

The lower reflective layer 130 and the upper reflective layer 170 may be, for example, a distributed Bragg reflector (DBR) obtained by repeatedly and alternately stacking a low refractive layer LR having a relatively low refractive index and a high refractive layer HR having a relatively high refractive index. In the structure, reflection occurs on a boundary surface between the high refractive layer HR and the low refractive layer LR having different refractive indexes. Thus, a high reflectance may be obtained by equalizing phase differences of all reflected lights. Also, a reflectance may be adjusted as desired according to the number of stacks of pairs of the high refractive layer HR and the low refractive layer LR. Accordingly, an optical thickness, that is, a value obtained by multiplying a physical thickness and a refractive index of a material, of the high refractive layer HR and the low refractive layer LR in each of the lower reflective layer 130 and the upper reflective layer 170 may be an odd multiple of about λ/4, where λ is a resonance frequency of the optical device 100.

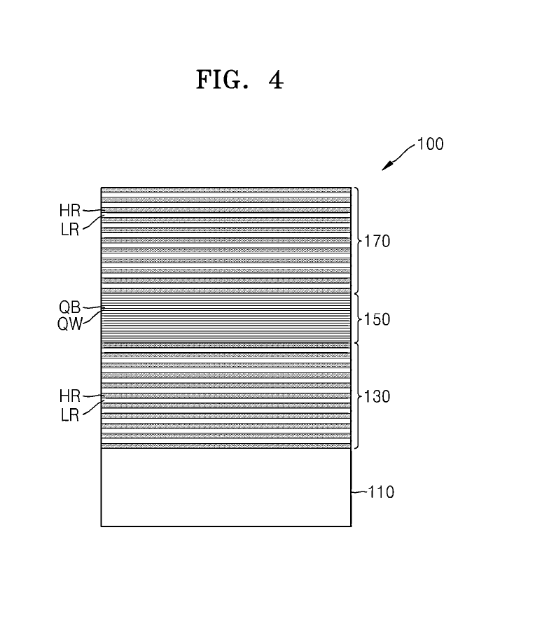

FIG. 5 is a cross sectional view schematically illustrating a structure of an optical device 101 according to a comparative example. Referring to FIG. 5, the optical device 101 according to the comparative example includes the lower reflective layer 130 formed on the GaAs substrate 111, an active layer 160, and the upper reflective layer 170. An etch stop layer ES is further formed between the GaAs substrate 111 and the lower reflective layer 130. A glass-lid GL is further formed on top of the upper reflective layer 170.

In the optical device 101, the active layer 160 is configured to function as a transmission type optical modulator that modulates a light in a wavelength band that is not transparent with respect to the GaAs substrate 111. For example, the active layer 160 may function as an optical shutter with respect to a light of a wavelength of about 850 nm. Accordingly, an area of the GaAs substrate 111 at a position corresponding to the active layer 160 is etched so that light may be incident on the active layer 160.

The thickness of each layer in the drawings is exaggerated for clarity. A total thickness of the lower reflective layer 130, the active layer 160, and the upper reflective layer 170 is smaller than 1/10 of the GaAs substrate 110 having a thickness of about 400 μm. Accordingly, when the GaAs substrate is being etched to support the structure consisting of the lower reflective layer 130, the active layer 160, and the upper reflective layer 170 having a thin thickness, the glass-lid GL is further formed on top of the upper reflective layer 170. Also, the etch stop layer ES is further provided so that the lower reflective layer 130 is not damaged when the GaAs substrate 110 is etched.

A process of manufacturing the optical device 101 according to the comparative example having the above structure has more operations than a process of manufacturing the optical device 100 of FIG. 4. Also, the optical device 101 has a larger size than the optical device 100 of FIG. 4. In other words, when the optical devices 100 and 101 are embodied to have the same size, the optical device 101 according to the comparative example has a relatively smaller effective area.

Since the optical device 100 according to the present embodiment uses a light in a wavelength band that is transparent with respect to the GaAs substrate 110 and also includes the active layer 150 to modulate the light, an optical device may be manufactured with a reduced number of processes and may have a large effective area.

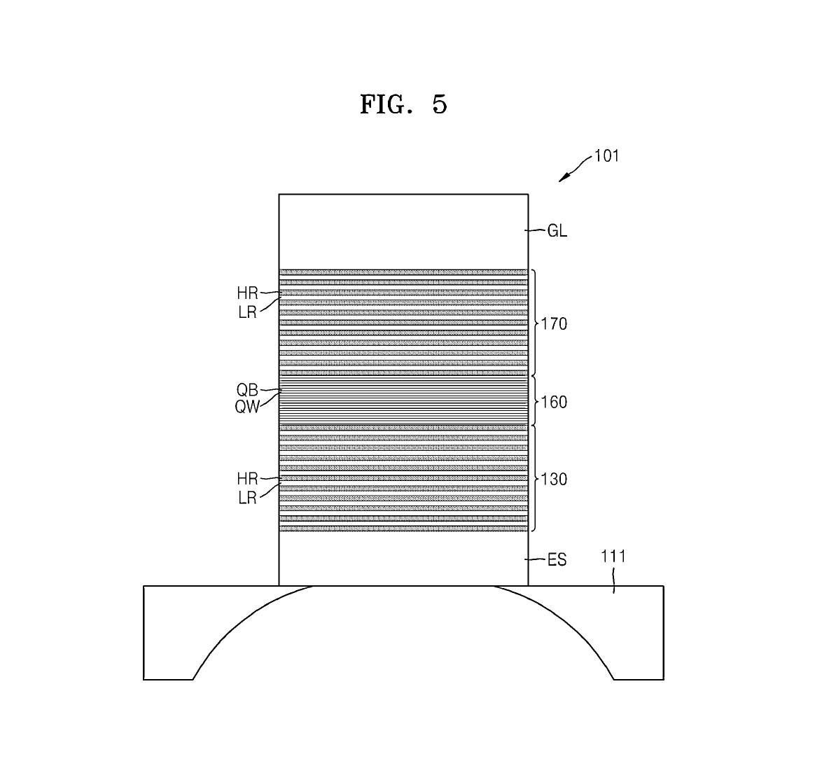

FIG. 6 is a cross sectional view schematically illustrating a structure of an optical device 200 according to another embodiment. Referring to FIG. 6, the optical device 200 according to the present embodiment includes a GaAs substrate 210, a lower reflective layer 230, an active layer 250, and an upper reflective layer 270. The active layer 250 has a MQW structure including a plurality of pairs of the QB layer and the QW layer. The active layer 250 has substantially the same structure as the active layer 150 of FIG. 4 to modulate a light in a wavelength band that is transparent with respect to the GaAs substrate 210.

A first microcavity layer 232 and a second microcavity layer 272 are formed in the lower reflective layer 230 and the upper reflective layer 270, respectively. The active layer 250 is a main cavity for Fabry-Perot resonance and the first and second microcavity layers 232 and 272 are additional cavities for Fabry-Perot resonance. The optical thickness of the first and second microcavity layers 232 and 272 may be an integer multiple of λ/2. The first microcavity layer 232 and the second microcavity layer 272 may be formed of the same material as one of the high refractive layer HR and the low refractive layer LR of either the lower reflective layer 230 or the upper reflective layer 270. Although FIG. 6 illustrates that the first microcavity layer 232 and the second microcavity layer 272 are respectively arranged in the lower reflective layer 230 and the upper reflective layer 270, this is only exemplary and any one thereof may be omitted.

An anti-reflection layer Ar may be further formed on a lower surface of the GaAs substrate 210.

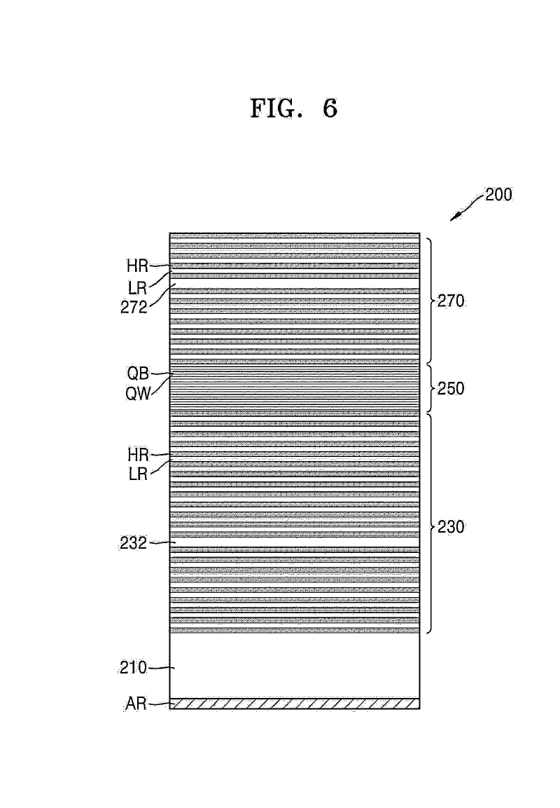

FIG. 7A is a transmission electron microscopy (TEM) image of a MQW structure layer of the optical device 200 of FIG. 6. FIG. 7B is an enlarged view of an inverse fast Fourier transform (IFFT) pattern of a partial area of FIG. 7A.

In the optical device 200 of FIG. 6 that is manufactured to obtain a TEM image, a pair of the QW layer and the QB layer is formed of InGaAs/GaAsP to a thickness of 7λ and the lower reflective layer 230 and the upper reflective layer 270 are formed in a DBR stack structure of AlGaAs/AlGaAs.

Referring to FIGS. 7A and 7B, it may be seen that a lattice match of a MQW structure to the GaAs substrate 210 is performed well. When the lattice match is not performed well, a linear pattern showing in the IFFT pattern has a discontinuous form.

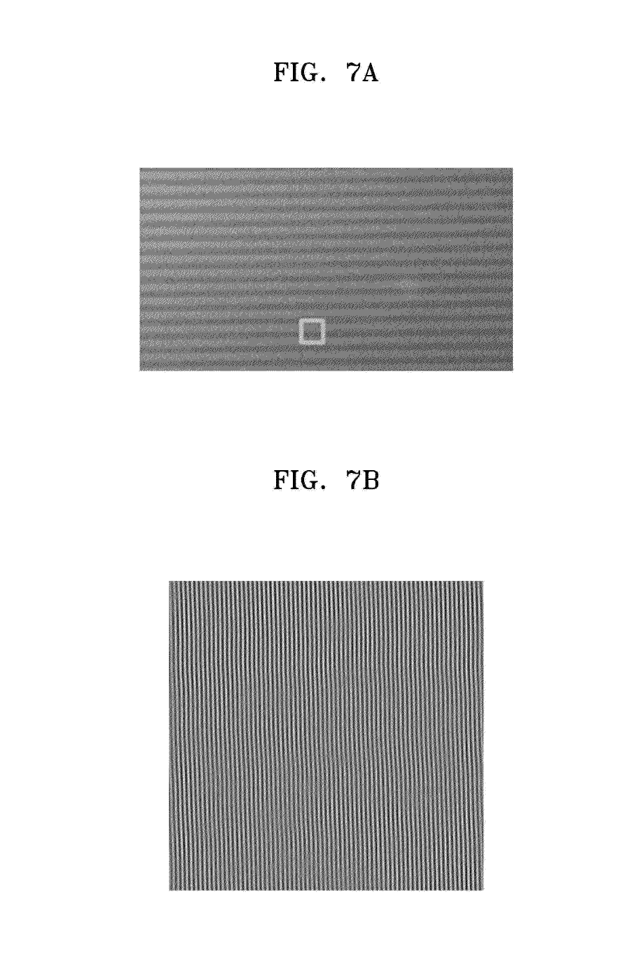

FIG. 8 is a graph showing a result of measurement of a photoluminescence (PL) characteristic of the optical device of FIG. 6. Referring to the graph of FIG. 8, it is apparent that a peak of light emission is formed at about 925.4 nm and a resonance wavelength of a value similar to the one expected from the computer simulated graph of FIG. 3A is formed.

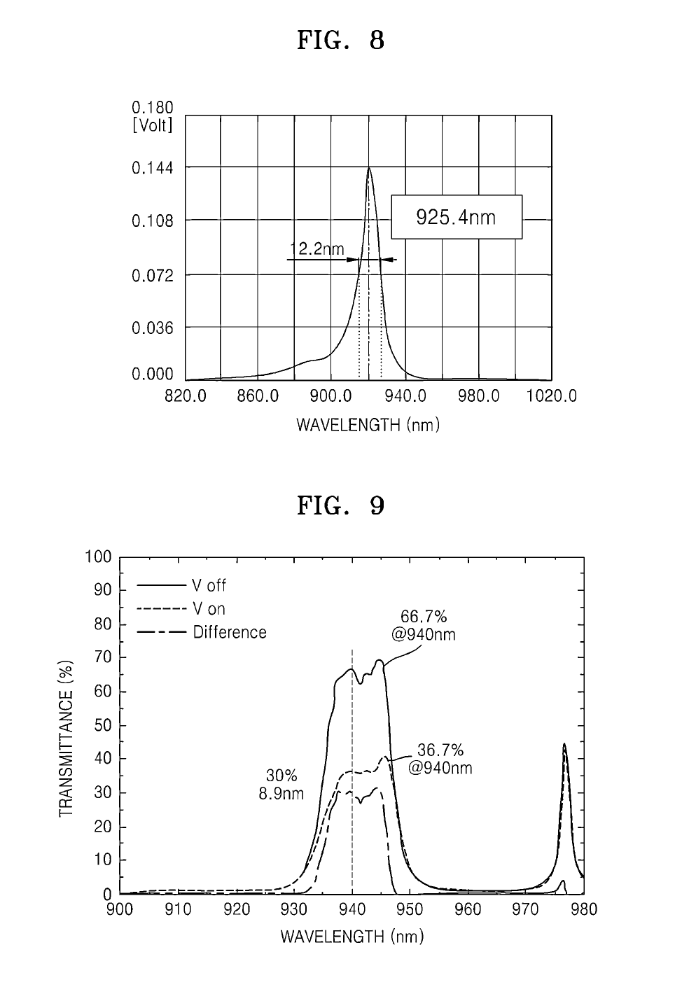

FIG. 9 is a graph showing transmittances when the optical device 200 of FIG. 6 is turned on and off and a difference in the transmittance between the case when the optical device 200 of FIG. 6 is turned on and the case when the optical device 200 of FIG. 6 is turned off. Referring to FIG. 9, with respect to a light of a wavelength of about 940 nm, a transmittance when no voltage is applied is about 66.7% and a transmittance when a voltage to is applied is about 36.7%. A difference in the transmittance is about 30%. Although the graph of FIG. 9 shows that a difference in the transmittance is rather low, the result is similar to the result expected from the computer simulation of FIG. 3B. Accordingly, a manufactured optical device may be capable of performing an optical shutter function with respect to a light of a wavelength of about 940 nm.

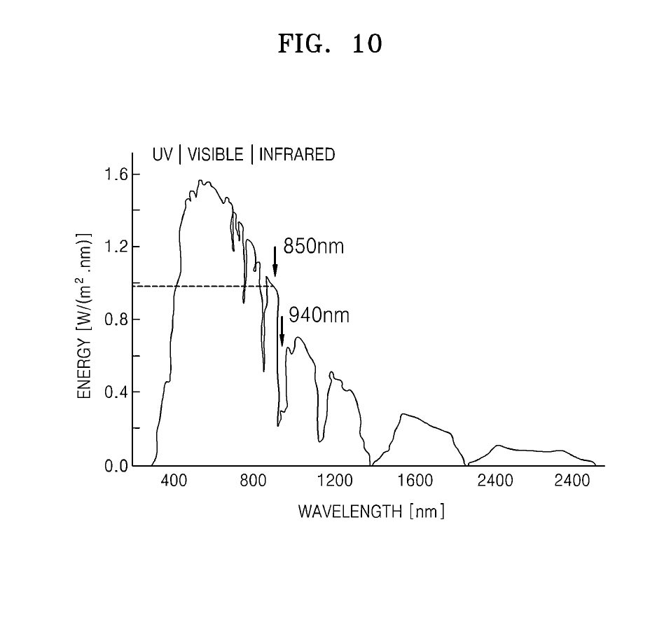

FIG. 10 is a graph showing a solar light spectrum. Referring to FIG. 10, a solar light of a wavelength of about 940 nm has less energy than a solar light of a wavelength of about 850 nm. Considering that the optical device 101 of FIG. 5 according to the comparative example performs an optical shutter function with respect to a light of a wavelength of about 850 nm, it is expected that the optical devices 100 and 200 have low noise due to a solar light.

As described above, the optical device 100 or 200 may function as an optical shutter with respect to a light in a wavelength band that is transparent with respect to the GaAs substrates 110 and 210. Also, since an efficiency of an effective area is high and noise due to external light is low, an optical modulation performance of the optical device 100 or 200 is high.

The optical device 100 or 200 may be applied to a three-dimensional (3D) sensor for sensing a position of an object by using a time-of-flight (TOF) algorithm, a depth image acquisition apparatus for acquiring a depth image of an object, a 3D image acquisition apparatus for acquiring a 3D image by combining a depth image and a two-dimensional (2D) image, etc.

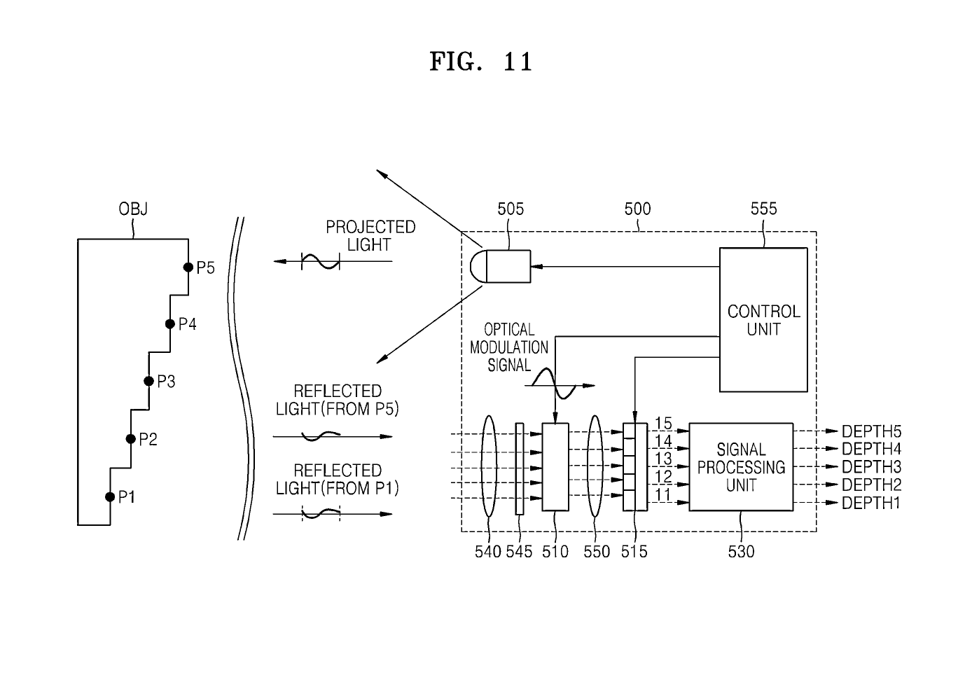

FIG. 11 schematically illustrates a structure of a depth image acquisition apparatus 500 according to an embodiment. Referring to FIG. 11, the depth image acquisition apparatus 500 is configured to extract depth information of an object using a TOF algorithm and may include the optical device 100 or 200 as a transmission type optical modulator.

The depth image acquisition apparatus 500 includes a light source 505 for irradiating a light in a predetermined wavelength band to an object OBJ, a transmission type optical modulator 510 for modulating light reflected from the object OBJ, a first image sensor 515 for sensing light that is modulated by the transmission type optical modulator 510 and converting the light into an electric signal, and a signal processing unit 530 for generating depth image information based on an output of the first image sensor 515. Also, the depth image acquisition apparatus 500 may include a control unit 555 for controlling operations of the light source 505, the transmission type optical modulator 510, the first image sensor 515, and the signal processing unit 530.

Also, the depth image acquisition apparatus 500 may further include a lens 540 for focusing the infrared light reflected from the object OBJ on the transmission type optical modulator 510. Also, a bandpass filter 545 for transmitting a light in a predetermined wavelength band only from among the light reflected from the object OBJ may be further provided between the lens 540 and the transmission type optical modulator 510. For example, the bandpass filter 545 may transmit only a light in a wavelength band irradiated from the light source 505. The order of arrangement of the lens 540 and the bandpass filter 545 may be reversed. A lens 550 for focusing the light modulated by the transmission type optical modulator 510 on the first image sensor 515 may be further provided between the transmission type optical modulator 510 and the first image sensor 515.

The light source 505 may be configured to irradiate an infrared light in a wavelength band between about 80 nm to about 1600 nm. A light emitting diode (LED) or a laser diode (LD) may be used as the light source 505, but the current embodiment is not limited thereto.

The light source 505 is controlled according to a control signal received from the control unit 555 and may project amplitude-modulated light to the object OBJ. Accordingly, the projected light from the light source 505 onto the object OBJ may have periodic continuous form with a predetermined cycle. For example, the projected light may have a specially defined waveform such as a sine waveform, a lamp waveform, or a square waveform, but may also have a general waveform that is not defined. Also, the light source 505 may periodically and intensively project light onto the object OBJ only for a predetermined period of time under the control of the control unit 555.

The transmission type optical modulator 510 modulates the light reflected from the object OBJ, and any of the optical devices 100 and 200 of FIGS. 4 and 6 may be employed therefor. The transmission type optical modulator 510 modulates the light reflected from the object OBJ according to the control of the control unit 555. The transmission type optical modulator 510 may modulate the amplitude of the projected light by changing a gain according to an optical modulation signal having a predetermined waveform. To this end, the transmission type optical modulator 510 may have a variable gain. The transmission type optical modulator 510 may operate at a high modulation speed of about tens to hundreds of megahertz (MHz) to identify a phase difference or a moving time of light according to a distance.

The first image sensor 515 detects the light modulated by the transmission type optical modulator 510 under the control of the control unit 555 and generates a sub-image. When only a distance from any one point of the object OBJ is measured, the first image sensor 515 may use a single optical sensor such as a photodiode or an integrator. However, when distances from a plurality of points of the object OBJ are simultaneously measured, the first image sensor 515 may have a two-dimensional (2D) or one-dimensional (1D) array of a plurality of photodiodes or other photodetectors. For example, the first image sensor 515 may be a charge-coupled device (CCD) image sensor or a complementary metal oxide semiconductor (CMOS) image sensor having a 2D array. The first image sensor 515 may generate one sub-image for each reflective light.

The signal processing unit 530 may generate depth information based on an output of the first image sensor 515 and also may generate an image including the depth information. The signal processing unit 530 may be, for example, a dedicated integrated circuit (IC) or software installed in the depth image acquisition apparatus 500. When the signal processing unit 530 is software, the signal processing unit 530 may be stored in a separate portable storage medium.

The projected light irradiated by the light source 505 is reflected from the surface of the object OBJ and is incident on the lens 540. Although an actual object may be formed of a 2D array of a plurality of surfaces at different distances from a photographing surface of the depth image acquisition apparatus 500, that is, depths, FIG. 11 exemplarily illustrates the object OBJ having five surfaces P1 to P5 having different depths for simplification of explanation. As the projected light is reflected from each of the surface P1 to P5, five reflected lights having different time delays, that is, different phases, are generated. A reflected light reflected from the surface P1 that is the farthest from the depth image acquisition apparatus 500 arrives at the lens 540 after a time delay TOF1. A reflected light reflected from the surface P5 that is the closest from the depth image acquisition apparatus 500 arrives at the lens 540 after a time delay TOF5 that is smaller than TOF1.

The reflected light is incident on the transmission type optical modulator 510. Background light or stray light other than the light irradiated by the light source 505 is removed by the bandpass filter 545.

The amplitudes of reflected lights having different phase delays are modulated by the transmission type optical modulator 510. While the reflected lights pass through the lens 540, magnification ratios of the reflected lights are adjusted and the reflected lights are refocused. Then, the reflected lights arrive at the first image sensor 515. The first image sensor 515 receives the modulated light and converts the modulated light into an electric signal. Output signals 11 to 15 of the first image sensor 515 include different depth information. The signal processing unit 530 produces information about depths Depth 1 to Depth 5 corresponding to the surfaces P1 to P5 of the object OBJ based on the depth information and generates an image including the depth information.

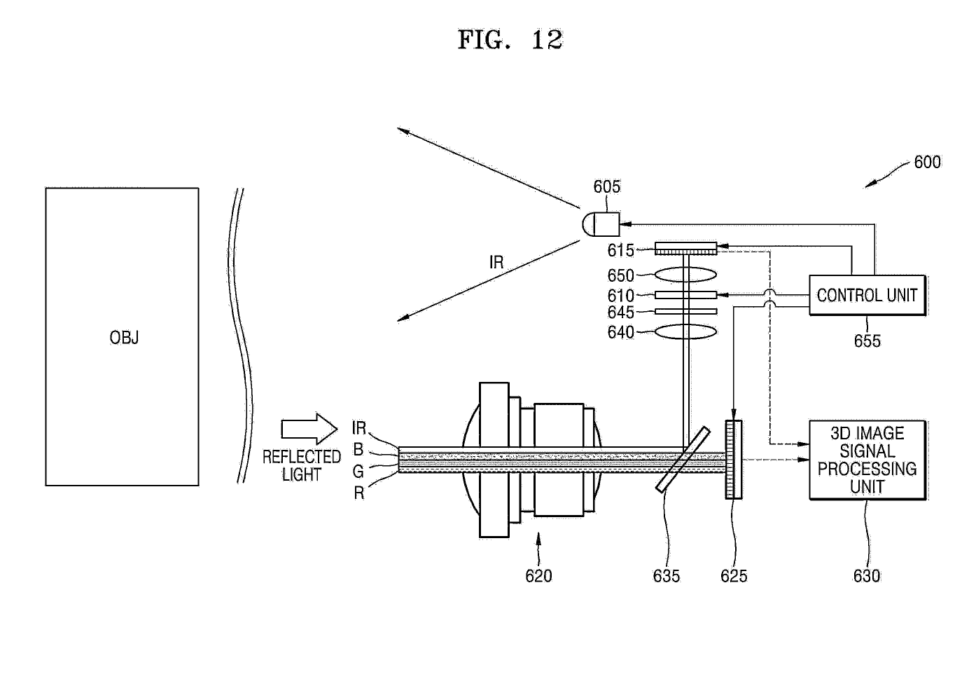

FIG. 12 schematically illustrates a structure of a 3D image acquisition apparatus 600 according to an embodiment. Referring to FIG. 12, the 3D image acquisition apparatus 600 acquires a 3D image via a structure for photographing a 2D color image and a structure for extracting depth information of an object by using TOF. The 3D image acquisition apparatus 600 also includes the optical device 100 FIG. 4 or the optical device 200 of FIG. 6 as a transmission type optical modulator for extracting depth information. Since an operation of acquiring depth information of an object in the 3D image acquisition apparatus 600 is the same as that described with reference to FIG. 11, a detailed description thereof will be omitted herein.

The 3D image acquisition apparatus 600 includes a light source 605 for irradiating an infrared light to the object OBJ, the infrared light being in a wavelength band between about 880 nm to about 1600 nm, a transmission type optical modulator 610 for modulating the infrared light reflected from the object OBJ, a first image sensor 615 for sensing light that is modulated by the transmission type optical modulator 610 and converting the light into an electric signal, a photographing lens 620 for focusing visible lights R, G, and B reflected from the object OBJ and forming an optical image, a second image sensor 625 for converting the optical image formed by the photographing lens 620 to an electric signal, and a 3D image signal processing unit 630 for generating depth information and color information based on electric signals output from the first image sensor 615 and the second image sensor 625 and generating a 3D image of the object OBJ. Also, the depth image acquisition apparatus 600 may include a control unit 655 for controlling operations of the light source 605, the transmission type optical modulator 610, the first image sensor 615, the second image sensor 625, and the 3D image signal processing unit 630.

The 3D image acquisition apparatus 600 may further include a beam splitter 635 for splitting the light reflected from the object OBJ so that an infrared light IR proceeds toward the first image sensor 615 and a visible light proceeds toward the second image sensor 625.

A lens 640 for focusing the infrared light IR split by the beam splitter 635 on the transmission type optical modulator 610 may be further provided between the beam splitter 635 and the transmission type optical modulator 610. Also, a bandpass filter 645 for transmitting only a light in a predetermined wavelength band of the light reflected from the object OBJ may be further provided between the beam splitter 635 and the transmission type optical modulator 610. For example, the bandpass filter 645 may transmit only a light in a wavelength band that is irradiated from the light source 605. The order of arrangement of the lens 640 and the bandpass filter 645 may be reversed. A lens 650 for focusing the light modulated by the transmission type optical modulator 610 on the first image sensor 615 may be further provided between the transmission type optical modulator 610 and the first image sensor 615.

Although FIG. 12 illustrates that the infrared light IR and the visible lights R, G, and B reflected from the object OBJ commonly pass through the photographing lens 620, an optical arrangement may be changed such that only the visible lights R, G, and B pass through the photographing lens 620, and infrared light IR does not pass through the photographing lens 620 and are incident on the transmission type optical modulator 610.

The transmission type optical modulator 610 modulates the light reflected from the object OBJ and the optical device 100 of FIG. 4 or the optical device 200 of FIG. 6 may be employed as the transmission type optical modulator 610. The transmission type optical modulator 610 modulates the light reflected from the object OBJ according to the control of the control unit 655. The transmission type optical modulator 610 may modulate an amount of the projected light by changing a gain according to an optical modulation signal having a predetermined waveform. The modulated light is sensed by the first image sensor 615. The first image sensor 615 outputs a signal having depth information of the object OBJ. Also, the second image sensor 625 outputs a signal having color information of the object OBJ. The 3D image signal processing unit 630 generates a 3D image signal based on the outputs of the first image sensor 615 and the second image sensor 625.

The optical device is capable of shuttering the light of a wavelength band that is transparent with respect to the GaAs substrate. Thus, the optical device may be employed as a transmission type optical modulator. As the optical device has a high effective area rate, a transmission type optical modulator with a relatively smaller size may be embodied.

As the optical device does not need a process of etching the GaAs substrate, an etch stop layer forming process for an etching process is unnecessary. Therefore, a process of manufacturing the optical device may be simplified. In addition, the optical device may be employed as a transmission type optical modulator, a 3D sensor, a depth image acquisition apparatus, and a 3D image acquisition apparatus.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more exemplary embodiments have been described with reference to the figures, it will be understood by those of ordinary skill in the art that various changes in form and details may be made therein without departing from the spirit and scope as defined by the following claims.

What is claimed is:

1. An optical device comprising:
a gallium arsenide (GaAs) substrate; and
a multiple quantum well structure formed on the GaAs substrate and having a quantum well layer and a quantum barrier layer,
wherein the quantum well layer is formed of a first semiconductor material that has a bandgap energy which is lower than that of the GaAs substrate and receives a compressive strain from the GaAs substrate, and
wherein the quantum barrier layer is formed of a second semiconductor material that has a bandgap energy which is higher than that of the GaAs substrate and receives a tensile strain from the GaAs substrate.

2. The optical device of claim 1, wherein the bandgap energy of the quantum well layer is lower than about 1.43 eV, and a lattice constant of the quantum well layer is higher than that of the GaAs substrate.

3. The optical device of claim 2, wherein the quantum well layer comprises Inₓ₁Ga₁₋ₓ₁As, wherein 0<x1≦0.35, or In_{1-x1-y1}Alₓ₁Ga_{y1}As, wherein 0<x1≦0.44 and 0≦y1≦0.98.

4. The optical device of claim 1, wherein the bandgap energy of the quantum barrier layer is higher than about 1.43 eV, and a lattice constant of the quantum barrier layer is lower than that of the GaAs substrate.

5. The optical device of claim 4, wherein the quantum barrier layer comprises GaAsₓ₂P₁₋ₓ₂, wherein 0.28≦x2≦1, Inₓ₂Ga₁₋ₓ₂P, wherein 0<x2≦0.34, or Gaₓ₂In₁₋ₓ₂As_{y2}P_{1-y2}, wherein 0.5≦x2≦0.8 and 0.4≦y2≦0.77.

6. The optical device of claim 1, wherein the multiple quantum well structure has a lattice match to the GaAs substrate.

7. The optical device of claim 1, wherein an upper reflective layer and a lower reflective layer are respectively disposed on an upper portion and a lower portion of the multiple quantum well structure.

8. The optical device of claim 7, wherein the multiple quantum well structure is configured such that a position of a peak of an absorption spectrum varies based on an applied voltage within a wavelength band that is transparent with respect to the GaAs substrate.

9. The optical device of claim 8, wherein, in response to a resonance wavelength of the optical device being λ, the multiple quantum well structure has an optical thickness of 0.5 nλ, wherein n is a natural number.

10. The optical device of claim 9, wherein the multiple quantum well structure comprises at least ten pairs of the quantum well layer and the quantum barrier well.

11. The optical device of claim 8, wherein the quantum well layer comprises Inₓ₁Ga₁₋ₓ₁As, wherein 0<x1≦0.35 or In_{1-x1-y1}Alₓ₁Ga_{y1}As, wherein 0<x1≦0.44 and 0≦y1≦0.98.

12. The optical device of claim 11, wherein the quantum barrier well comprises GaAsₓ₂P₁₋ₓ₂, wherein 0.28≦x2≦1, Inₓ₂Ga₁₋ₓ₂P, wherein 0≦x2≦0.34, or Gaₓ₂In₁₋ₓ₂As_{y2}P_{1-y2}, wherein 0.5≦x2≦0.8 and 0.4≦y2≦0.77.

13. The optical device of claim 7, wherein at least one microcavity layer is disposed in at least one of the upper reflective layer and the lower reflective layer, and in response to a resonance wavelength of the optical device being λ, the at least one microcavity layer has an optical thickness that is an integer multiple of λ/2.

14. The optical device of claim 13, wherein each of the upper reflective layer and the lower reflective layer has an optical thickness of λ/4 and is a distributed Bragg reflector (DBR) layer in which a first refractive index layer and a second refractive index layer having different refractive indexes are alternately stacked.

15. The optical device of claim 14, wherein the microcavity layer is formed of a same material as one of the first refractive index layer and the second refractive index layer.

16. A depth image acquisition apparatus comprising:
a light source configured to irradiate an infrared light to an object, the infrared light being in a wavelength band between about 880 nm to about 1600 nm;
a transmission type optical modulator configured to modulate the infrared light reflected from the object, the transmission type optical modulator comprises the optical device of claim 7;
a first image sensor configured to sense a light modulated by the transmission type optical modulator and convert a sensed light into an electric signal; and
a signal processing device configured to generate depth information from an output of the first image sensor.

17. The depth image acquisition apparatus of claim 16, further comprising a lens device configured to focus the infrared light on the transmission type optical modulator.

18. The depth image acquisition apparatus of claim 17, further comprising a bandpass filter configured to transmit only a light in the wavelength band that is irradiated by the light source, the bandpass filter being disposed between the lens device and the multiple quantum well structure.

19. A three-dimensional (3D) image acquisition apparatus comprising:
a light source configured to irradiate an infrared light to an object, the infrared light being in a wavelength band between about 880 nm to about 1600 nm;
a transmission type optical modulator configured to modulate the infrared light reflected from the object, the transmission type optical modulator comprises the optical device of claim 7;
a first image sensor configured to sense a light modulated by the transmission type optical modulator and convert a sensed light into an electric signal;
a photographing lens configured to focus a visible light reflected from the object and form an optical image;
a second image sensor configured to convert the optical image formed by the photographing lens into an electric signal; and
a 3D image signal processing device configured to generate depth information and color information from electric signals output from the first image sensor and the second image sensor, and generate a 3D image of the object.

20. The 3D image acquisition apparatus of claim 19, further comparing a beam splitter configured to split the light reflected from the object such that the infrared light travels toward the first image sensor and a visible light travels toward the second image sensor.
